(19) United States
(12) Patent Application Publication
(10) Pub. No.: US 2015/0183361 A1
(43) Pub. Date: Jul. 2, 2015

(54) Loading Mechanism

(71) Applicant: Suelex Limited, Omokoroa, Tauranga (NZ)

(72) Inventor: Lex Noel Bacon, Omokoroa (NZ)

(21) Appl. No.: 14/411,050

(22) PCT Filed: Jun. 24, 2013
(86) PCT No.: PCT/NZ2013/000112

§ 371 Date: Dec. 23, 2014

(30) Foreign Application Priority Data
Jun. 23, 2012 (NZ) 597422
Dec. 13, 2012 (NZ) 604530

(51) Int. Cl. B60P 3/10; B60P 1/52

(52) U.S. Cl. CPC B60P 3/1066; B60P 1/52

(57) ABSTRACT

This invention relates to a loading mechanism, including a first roller assembly and second roller assembly, at least one mounting for the first and second roller assemblies, wherein the first roller assembly and second roller assembly each have a longitudinal axis, a drive mechanism configured to rotate the first roller assembly and second roller assembly, so as to move an object, wherein as the weight of the object applies pressure to at least one of the first and second roller assemblies the mounting allows the roller assemblies to move so as to change the angle between the longitudinal axis of the first and second roller assemblies.

### TECHNICAL FIELD

The present invention relates to a loading mechanism.

### BACKGROUND ART

Trailers are used to store and transport boats.

The loading and unloading of a boat onto the trailer is facilitated by rollers mounted on the trailer. The boat is moved over the rollers to move it onto or off from (load/unload) the trailer.

The simplest mechanical way to load or unload a boat is to push it. However, significant strength is required to move a heavy boat over rollers. This means that many boat users may struggle to push a boat so as to load and unload it from a trailer.

Winches are often used to drag boats out of the water, over rollers, and thereby onto the trailer. However, these can be fiddly to use. It is necessary to align the boat with the trailer and secure the winch rope to the front of the boat. This can be difficult to achieve. In addition, a boat user often gets wet which many people wish to avoid.

Furthermore, manual winches still require strength or effort to load the boat. Again, not all boat users possess sufficient strength to load the boat.

A further problem of many boat trailers is that these must be submerged in water in order for a boat to be loaded onto the trailer. Exposure of the trailer to water, and in particular salt water, can accelerate the rate of rusting of the trailer and its components.

Automatic boat trailers are known and an example is described in PCT Application No. 2004/000667. The device disclosed by this patent includes a plurality of rollers spaced apart along a boat trailer's length, and located approximately in line with the centre line of the trailer. Those rollers are aligned along <the centre of the trailer. The rollers are connected by a chain drive mechanism so that a motor can rotate all of the rollers. However, this arrangement requires that a person accurately aligns a boat with the rollers. This often can be logistically difficult to achieve. It can also result in the person getting wet—again something which may wish to be avoided.

A further issue with the boat trailer disclosed by PCT Application No. 2004/000667 is that the chain drive mechanism has exposed moving parts such as the drive chain. Those parts may be susceptible to rusting, which can be accelerated due to exposure to salt water or other damage.

That chain drive mechanism may also pose a safety risk due to the exposed/moving parts.

Yet a further problem of the boat trailer disclosed in this patent is that the rollers struggle to transfer sufficient force to the boat to efficiently move that onto and off from a trailer. This is a result of the position of the rollers, and that they are fixed with respect to the trailer.

A further type of boat trailer is disclosed by New Zealand Patent No. 547569. This includes a Y shaped frame with a draw bar to engage a corresponding coupling on a vehicle. A ‘U’ shaped frame sits inside and is pivotably mounted to the Y shaped frame. A pair of swivel arms is configured to move the U shaped frame so as to raise and lower a boat with respect to the Y shaped frame.

The device of New Zealand Patent No. 547569 was designed to facilitate launching of boats in shallow water. However, this type of boat trailer cannot easily be used with launching boats on inclined launching areas such as boat ramps.

Furthermore, the boat trailer of Patent No. 547569 requires submersion of the trailer in water. As discussed above, such submersion can lead to wear and tear or rusting of the components.

It is therefore an objective of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

It is an object of the present invention to address the foregoing problems or at least to provide the public with a useful choice.

Further aspects and advantages of the present invention will become apparent from the ensuing description which is given by way of example only.

### DISCLOSURE OF THE INVENTION

According to one aspect of the present invention there is provided a loading mechanism, including

at least two roller assemblies,

at least one mounting for the at least two roller assemblies,

a drive mechanism configured to rotate the at least two roller assemblies,

characterised in that

in use the drive assembly rotates the at least two roller assemblies so as to move an object, and wherein

that as the weight of the object applies pressure to the at least two rollers assemblies the mounting allows the roller assemblies to move so as to change the orientation of at least two of the roller assemblies relative to each other.

According to another aspect of the present invention there is provided a kitset of parts, including

at least two roller assemblies,

at least one mounting for the at least two roller assemblies,

a drive mechanism,

characterised in that

when assembled and in use, the drive mechanism rotates the at least two roller assemblies so as to move an object, and wherein as the weight of the object applies pressure to the at least two roller assemblies the mounting allows the roller assemblies to move so as to change the orientation of at least two of the roller assemblies relative to each other.

According to another aspect of the present invention, there is provided a loading method, wherein the method uses a loading mechanism including at least two roller assemblies, a drive mechanism, and at least one mounting for the roller assemblies,

the method including the steps of:
(a) using the drive mechanism to rotate the at least two roller assemblies so as to move the object, and wherein the weight of the object applies pressure to the roller assemblies so as to cause the roller assemblies to move and thereby change the orientation of at least two of the roller assemblies relative to each other.

Throughout the present specification, reference to the term “loading mechanism” should be understood as meaning an assembly to move an object on to or off from a cradle.

The term “cradle” refers to a plurality of components that can support an object.

The cradle has a front end, a back end, and a center line extending along its length.

Reference to the terms “front end” and “backward end” are arbitrary, referring and made with reference to the normal direction of loading an object onto the cradle of a preferred embedment to the present invention. These references should not be seen as anyway limiting on the scope of the present invention.

The cradle may also include supplementary rollers. In-use these assist moving the object onto or off from the cradle. The supplementary rollers may also define the cradle.

In a preferred embodiment the present invention relates to a loading mechanism for objects with a width and/or shape which varies along its length.

In a particularly preferred embodiment the present invention relates to a loading mechanism for use in loading and unloading boats onto a cradle on a trailer. Accordingly, reference herein will be made to use of the loading mechanism with boats and trailers.

However, the foregoing should not be seen as limiting on the scope of the present invention. It is also envisaged that the loading mechanisms can be used with loading boats onto objects other than trailers such as a dry dock berth or non-trailer cradles.

It is also envisaged that the loading mechanisms according to the present invention may be utilised in applications such as loading and unloading of jet skis, or loading and unloading of heavy objects such as containers.

Preferably, the boats with which the present invention is used have a centre line. The boat is symmetrical (a mirror image) about the centre line. However, the boat's width and therefore its shape varies along the length of the boat. This is a common design feature of boats and is as should be understood by one skilled in the art.

Throughout the present specification reference to the term “roller assembly” should be understood as meaning rotatable components. In use, a roller assembly rotates so as to move a boat in a direction corresponding to the direction of rotation.

In a particularly preferred embodiment, the present invention includes at least two roller assemblies spaced apart across the width of a trailer so as to be on either side of the centre line of the cradle. Therefore, in-use the two roller assemblies are on either side of the centre line of a boat with which the loading mechanism is to be used.

The inventors have discovered that having roller assemblies which in use are on either side of the boat's centre line provides a number of advantages. For instance, the roller assemblies are better positioned to engage the boat's hull as the boat approaches the trailer. This enables the roller assemblies to act as an aligning mechanism, which moves the boat towards, or into, an optimum position. When the boat is in the optimum position the roller assemblies can better apply force to the boat to load that onto the trailer.

It is also envisaged that the present invention may include a plurality of roller assemblies spaced apart along the length of the trailer. Therefore the foregoing should not be seen as limiting on the scope of the present invention.

In a preferred embodiment a roller assembly may be a plurality of individual rollers. The rollers may be mounted on a common axle or otherwise coaxial with each other.

However, it is also envisaged that a roller assembly could be a single (integral) roller. Therefore the foregoing should not be seen as limiting on the scope of the present invention.

Throughout the present specification reference to the term “drive mechanism” should be understood as meaning a component that is configured to rotate a roller assembly.

In a preferred embodiment a drive mechanism includes at least one motor connected to a roller assembly.

In a particularly preferred embodiment the drive mechanism includes a pneumatic drive system. The pneumatic drive system may include a primary drive, which powers a plurality of motors.

However, the forgoing should not be seen as limiting on the scope of the present invention and alternatives are envisaged, including one electric motor per roller assembly or hydraulic drive systems comprising one or more hydraulic pumps configured to drive rotation of a hydraulic motor.

In a preferred embodiment, the drive mechanism is configured to rotate the rollers at a rate of between 6-15 revolutions per minute, and more preferably 10 revolutions per minute.

The inventor has identified that this range of rotating rates for the rollers is particularly advantageous in ensuring that the present invention works successfully. Without being limited the inventors believes that these rates of rotation help to ensure that the rollers are better able to engage the boat hull surface to transfer force to the boat hull (which is necessary to move the boat). If the rollers rotate too quickly then they slip over the boat hull. If the rollers rotate to slowly then the time taken to load and unload the boat onto the trailer is too long.

It should also be appreciated that the roller diameter has an effect on the rate of rotation required to move a boat onto and off from the trailer within a useful timeframe. Accordingly, the forgoing should not be seen as limiting on the scope of the present invention.

In a preferred embodiment the drive mechanism includes a square drive.

Throughout the present specification reference to the term “square drive” should be understood as meaning a non-circular axle. In use, the axle is disposed in a correspondingly shaped aperture in a roller.

The inventor's have found that the square drive provides a particularly efficient way to transfer force from motors to the rollers. This is beneficial in helping to reduce the complexity of parts used in the drive assemblies and minimising the weight of the present invention. Further, the square drive may reduce slippage of the rollers on the axle which might occur using other configurations and arrangements.

The square drive system also helps the rollers to be held in spaced apart positions along the axle. This is beneficial in compensating for problems due to planning lines on a boat hull. As the rollers are spaced apart they may be better able to flex. This means that the roller can maintain contact with the hull which may help to transfer sufficient force to the hull to move the boat.

However, the foregoing should not be seen as limiting on the scope of the present invention and alternatives are envisaged.

Throughout the present specification reference to the term “mounting” should be understood as meaning a component to which one or more roller assembly is secured.

In a particularly preferred embodiment the present invention includes one mounting for each roller assembly.

The mounting assembly is configured to facilitate, or otherwise allow, the roller assemblies to move with respect to each other so as to change the orientation of the roller assemblies with respect to each other.

In a particularly preferred embodiment a mounting facilitates one or more roller assemblies pivoting by providing a pivot point between the roller assembly and the trailer.

However, this should not be seen as limiting as alternatives are envisaged. Those include a mounting formed by a track and guide assembly, in which a roller assembly slides through an arcuate path so as to change the orientation of the roller assemblies. This aspect of the present invention should become clearer from the following description.

Throughout the present specification reference to the term “orientation of at least two roller assemblies relative to each other” should be understood as meaning changing an internal axle of two axis, wherein each of the axis extend along the length of an axle of a roller assembly. However, the foregoing should not be seen as limiting on the scope of the present invention. Alternatives for assessing the orientation of the roller assemblies are envisaged.

In a particularly preferred embodiment, the mountings are configured to move the roller assemblies to a default position.

Throughout the present specification reference to the term “default position” should be understood as meaning a position for the roller assemblies at a given angle without any weight or pressure applied to them.

In a particularly preferred embodiment in the default position the roller assemblies form a “V” when viewed along the length of the trailer. That shape helps the roller assemblies to engage the forward part (bow) of a boat hull, and thereby may improve the present invention's effectiveness at loading a boat onto a trailer.

In a preferred embodiment, in the default position the internal angle of the “V” between the rollers is in the range of substantially 40°-50°, and more preferably substantially 45°.

In a preferred embodiment the mountings are configured to allow the roller assemblies to pivot so that the angle between the roller assemblies is substantially 180° e.g. the rollers/axles are substantially parallel. This range of motion helps the roller assemblies to maintain contact with the boat hull as it moves onto or off from the trailer. Therefore the range of motion helps to account for changes in the shape or width of the boat, and thereby may improve the present invention's efficiency.

In addition, the roller assemblies may be better able to transfer force to the boat hull e.g. there is a greater contact between the surface of the roller assembly and the boat hull than would have occurred were the roller assemblies held in a fixed position with respect to each other.

The inventors have also found that the preferred range of angles is useful to facilitate use of the present invention with a range of different boats differing in the shape and configuration of their respective hulls.

However, the foregoing should not be seen as limiting on the scope of the present invention.

In a preferred embodiment, rollers according to the present invention have a tread on their contact surface.

The tread may improve the roller's ability to grip a boat hull and therefore transfer force to the boat hull to move this on to or off from the cradle.

In addition, the tread provides channels to facilitate moving of water. This feature may also assist in the rollers maintaining contact with and transferring force to the boat hull. The function of the tread is similar to the function of a tread in vehicle tires as should be known to one skilled in the art.

However, the inventors have surprisingly found that use of rollers having a tread is particularly beneficial to function of the loading mechanism according to the present invention. This is surprising as existing industry wisdom is that rollers should preferably be smooth.

However, the foregoing should not be seen as limiting on the scope of the present invention, and it is also envisaged that rollers according to the present invention preferably have a substantially cylindrical shape. The rollers therefore have a long and round contact surface. That surface can help in smoothly loading a boat onto or off from a trailer by providing a large contact surface which can abut a boat hull.

In a particularly preferred embodiment the rollers may have an overhang.

Reference through the present specification to the term “overhang” should be understood as meaning that the contact surface of the roller is wider than the main body of the roller. This enables the rollers to flex or deform when under pressure in use. Therefore the roller may be able to wrap around, or deform to account for, features of shape in the boat hull. For instance, many boats have planning lines, being ridges extending along the boat's length. That the roller can flex enables it to maximise the surface area of the roller in contact with boat hull. This helps to maximise the transfer of rotational force to the boat hull and may improve the present invention's efficiency.

However, the foregoing should not be seen as limiting on the scope of the present invention and alternatives are envisaged including rollers that have a uniform cross section, are solid, or where the main body is wider than the contact surface.

In a preferred embodiment where the rollers have a tread they are formed from a material having a shore hardness in the range of substantially 40 to 80.

In a particularly preferred embodiment where the rollers have a thread are made from a material having a shore hardness of substantially 45

The inventors have identified that the hardness of the materials from which the rollers are made can have a significant effect on the invention's effectiveness. It is believed that this is because the rollers need to be resilient enough to transfer the force of rotation to the boat hull. However, the rollers must also be able to deform to the shape of the boat hull and therefore cannot be too hard.

Alternatively, if the roller is too soft then it is likely to be ripped or damaged through frictional abrasion caused by contact by the boat hull.

It is also envisaged that in embodiments where the rollers have a smooth cylindrical contact surface that they made be made from a material having a shore hardness in the range of substantially 50 to 80, or more preferably substantially 70.

However the foregoing should not be seen as limiting on the scope to the present invention as the rollers can be made from materials having a hardness outside of the preferred range.

It is also envisaged that the rollers could be made from a composite of two or more materials. In such an embodiment the contact surface may have a hardness in the range described herein, whereas the main body of the roller may be outside of that range.

It should be appreciated from the foregoing that the present invention provides a number of advantages over the prior art. These may include any or all of the following:
The kit set may be easily retrofitted to an existing trailer.
The movement of the rollers relative to each other as they rotate so as to move a boat helps to keep the rollers in contact with the boat's hull. Therefore the present invention is better able to transfer force to the boat and is better able to move them.
Is better able to automatically load and unload a boat, and can handle the increase in weight as the boat leaves the water.
Provides a self aligning mechanism to maneuver a boat into a position in which it can be loaded onto the trailer.
Is cost effective to manufacture.
Reliable.
Easily accounts for different boat hull shapes and can therefore be used with a variety of different boats.

### BRIEF DESCRIPTION OF DRAWINGS

Further aspects of the present invention will become apparent from the following description which is given by way of example only and with reference to the accompanying drawings in which:

FIG. 1A is a front perspective view of a trailer incorporating a loading mechanism according to the present invention in the default position;

FIG. 1B is a rear perspective view of FIG. 1A;

FIG. 2A is a perspective view of a loading mechanism according to the present invention;

FIG. 2B is a view of FIG. 2A with the roller assemblies in a different position to FIG. 2A;

FIGS. 3A-3D are schematics showing loading of a boat onto a trailer using a loading mechanism according to the present invention;

FIG. 4A-4C are end on views of schematics showing FIG. 3;

FIG. 5A is an end perspective view of a roller according to the present invention;

FIG. 5B is an end on view of FIG. 5A;

FIG. 6A is a first close up perspective view of a section of loading mechanism;

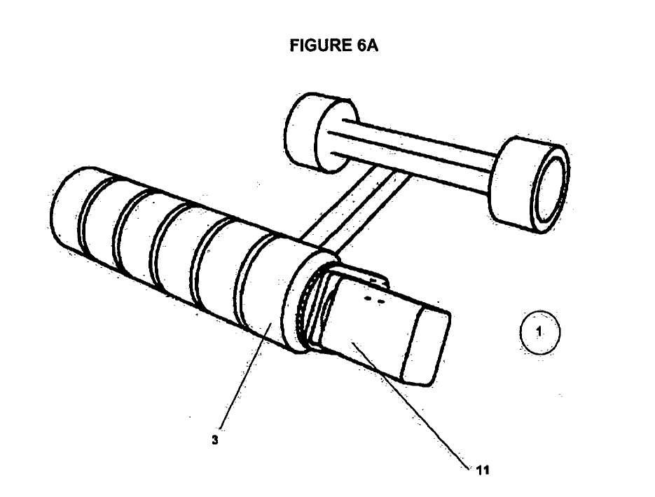

FIG. 6B is a second close up perspective view of the section of a loading mechanism shown in FIG. 6A.

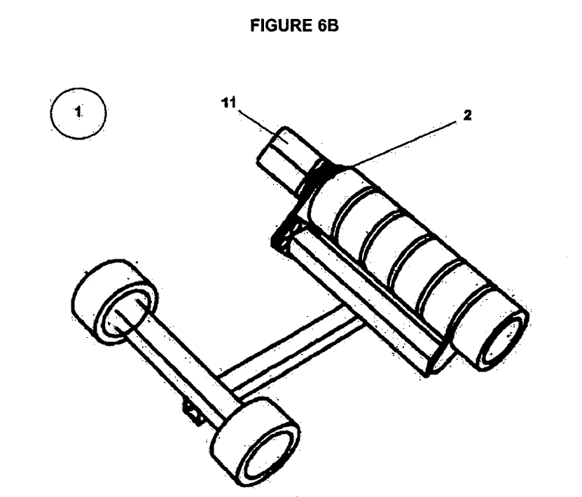

### BEST MODES FOR CARRYING OUT THE INVENTION

Aspects of the present invention have been described by way of example only and it should be appreciated that modifications and additions may be made thereto without departing from the scope thereof.

There is provided a loading mechanism generally indicated as (1). The loading mechanism (1) is secured to a boat trailer (1A).

The loading mechanism (1) may be sold as a kitset of parts including instructions on how to assemble the loading mechanism (1) to the boat trailer (1A). The instructions (not shown in the Figures) can include any or all of the steps discussed herein.

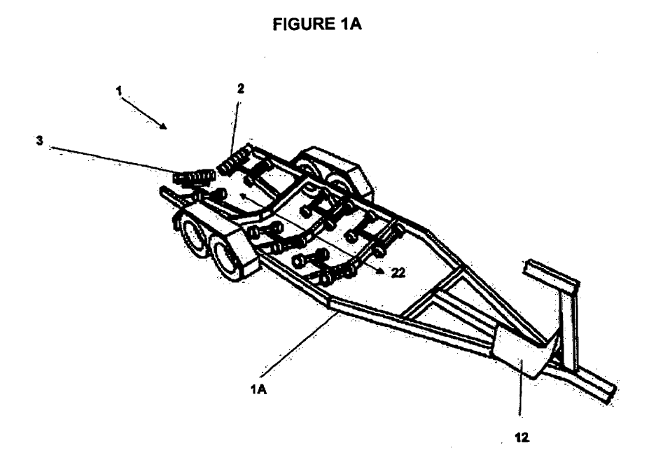

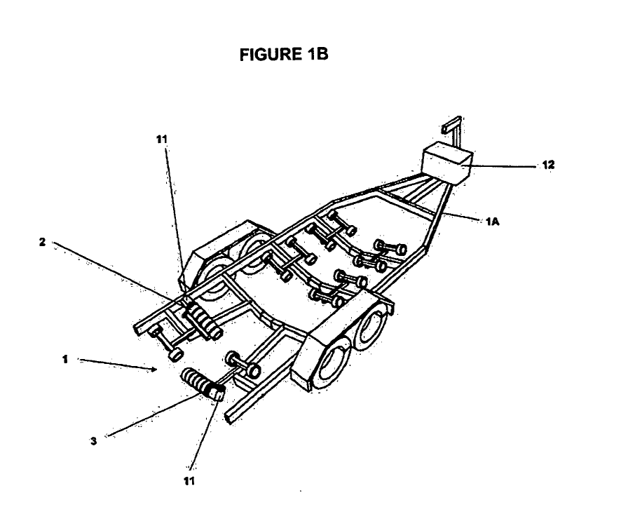

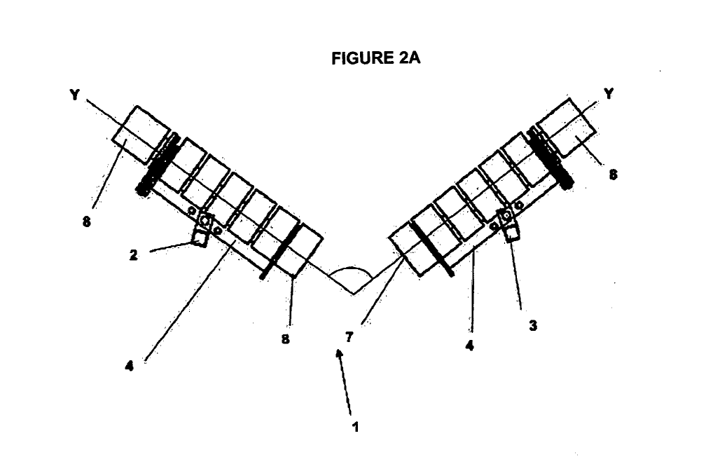

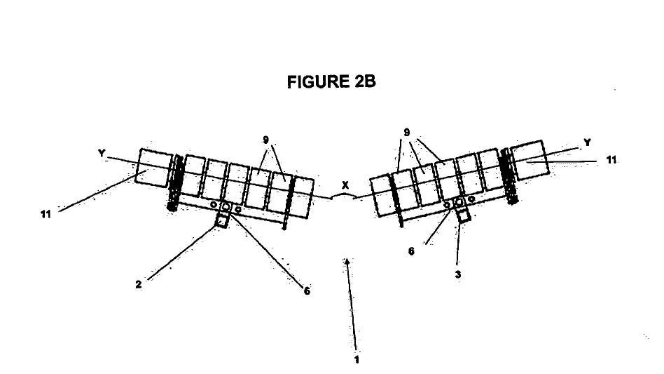

Referring first to FIGS. 1A, 1B, and FIGS. 2A, 2B.

However, the roller assemblies (2, 3) can pivot with respect to each other so as to change their orientation with respect to each other. In the embodiment shown in the Figures, the roller assemblies (2, 3) can pivot such that they are substantially parallel, with their axis (Y) aligned. This is important to roller assemblies (2, 3) transferring sufficient force to the boat (18) to move it onto or off from the trailer (1A).

The loading mechanism includes two roller assemblies (2, 3). Each of the roller assemblies (2, 3) are identical, and therefore only roller assembly (2) will be described. However, in the drawings, like references refer to like components.

Roller assembly (2) includes a mounting arm (4) which pivotally secures the roller assembly (2) to a trailer (5). The mounting arm (4) may be secured to a wobble roller mount as is known to one skilled in the art.

Roller assembly (2) is free to pivot about pivot point (6). The mounting arm is configured so that the weight of the roller assembly (2) causes it to pivot about pivot point (6) such that an inner end (7) of roller assembly (2) is lower than an outer end (8). Pivoting of the roller assemblies (2, 3) about pivot point (6) enables their orientation with respect to each other.

The orientation of the roller assemblies (2, 3) with respect to each other is best understood with reference to an imaginary axis indicated as (Y) in FIGS. 2A and 2B. The imaginary axis (Y) extends along the length of the axle (10).

The internal (X) between the imaginary axis (Y) changes as the roller assemblies (2,3) pivot about pivot point (6).

Roller assembly (2) has a plurality of rollers (9) that are each mounted on an axle (10). The rollers (9) are spaced apart from each other along the length of axle (10).

Spacing the rollers (9) apart allows them to flex independently of each other. Therefore, the rollers (9) may be better able to accommodate changes in shape of the boat hull (20), or plaining lines (23) which the rollers (9) may touch when moving a boat onto or off from a trailer (1A).

In addition, the rollers (9) are able to be easily cleaned. This can prevent damage to the rollers (9) by particulate matter (grit) or rusting caused by salt water.

A drive motor (11) is secured to mounting arm (4) and operatively coupled to an axle (10). In use, the drive motor (11) rotates and thereby causes the axle (10) to rotate. This in turn rotates rollers (9)—as will be discussed below.

Drive motor (11) is connected to hydraulic pump (12) mounted on trailer (1A). The hydraulic pump (12) has a capacity in the range of 165 cc-250 cc, and more preferably 200 cc.

An electric motor (not shown) is mounted to trailer and a battery (not shown). The battery provides a power source to drive rotation of electric motor.

The electric motor (not shown) drives hydraulic pump (12).

Hydraulic pump (12) is connected to drive motors (11) in parallel. Therefore, hydraulic pump (12) applies equal driving force to drive motors (11).

The connection of hydraulic pump (12) to drive motors (11) is such that it can control rotation of drive motors (11) in a clockwise or anticlockwise direction. This in turn enables the drive motors (11) to rotate the axles (10), and thereby the roller assemblies (2, 3), in either a clockwise or anticlockwise direction.

A remote (not shown) is able to communicate with hydraulic pump (12) and send signals which cause the pump (12) to engage and disengage. The remote can also tell hydraulic pump (12) which direct in to rotate roller assemblies (2,3). This allows a user to control rotation of roller assemblies (2, 3).

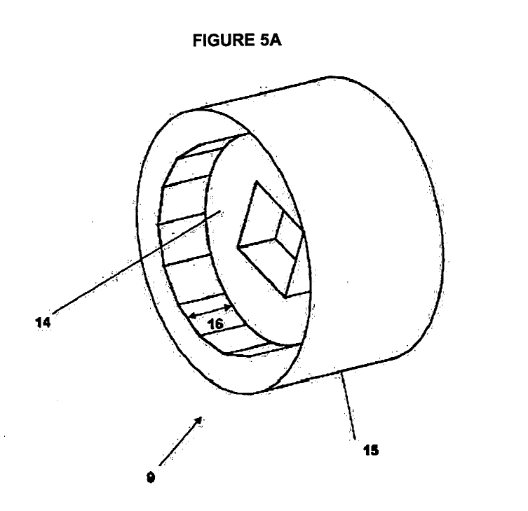

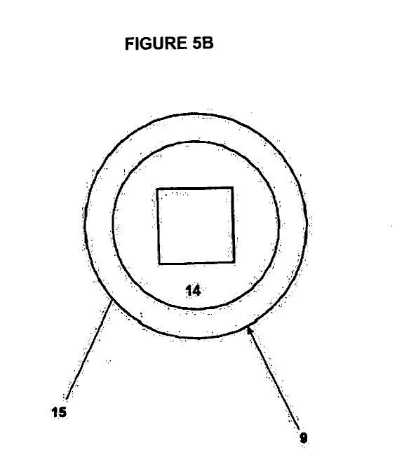

Referring now to FIGS. 5A and 5B which show features of one embodiment of the rollers (9).

The rollers (9) shown in FIGS. 5A and 5B have a substantially cylindrical shape. Each roller is made from polyurethane has a shore hardness of substantially 70.

Each roller (9) has a central main body (14) and a contact surface (15). The contact surface (15) is longer than the main body (14). This provides an overhang indicated by (16) whereby the contact surface (15) extends beyond the dimensions of the main body (14).

It is also envisaged that each roller (9) can have a shape and configuration generally similar to a type, having a tread on a contact surface of the roller (⁹).

### In Use

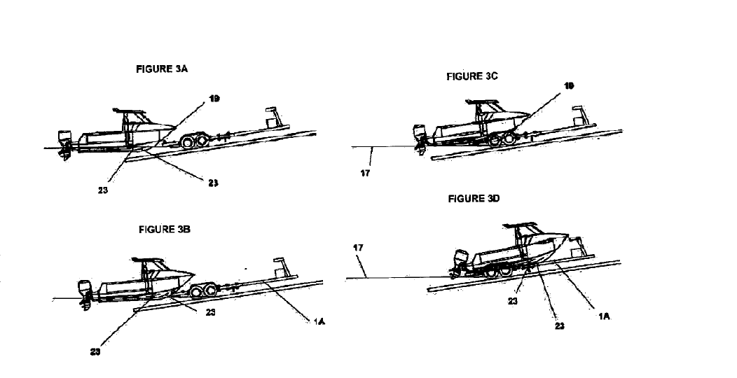

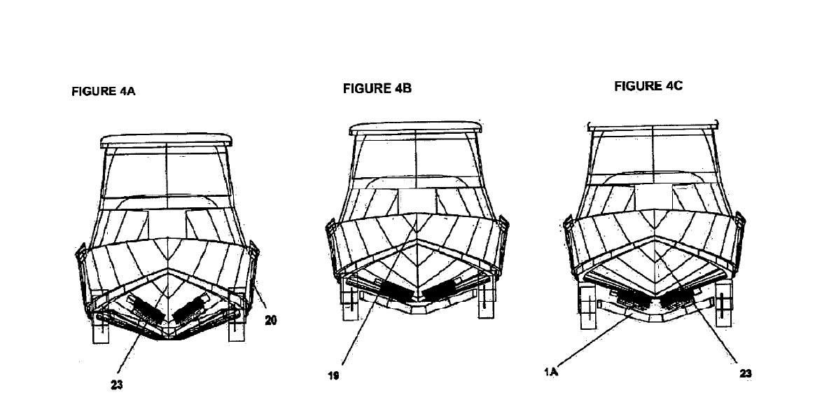

Referring now to FIGS. 3 and 4.

A vehicle (not shown) is used to position trailer (1A) with respect to a body of water (17).

Remote (not shown) is used to engage drive mechanism so that hydraulic pump (12) rotates drive motors (11). This in turn causes roller assemblies (2, 3) to rotate.

A boat (18) is moved so that bow (19) approaches loading mechanism (1).

One or both of roller assemblies (2, 3) abut boat hull (20) on the side of the boats centre line (21).

If the boat hull (20) is not in line with the central axis (22) of boat trailer (1A) then the force applied to boat hull (20) moves boat (18) so as to align its centre line (21) with the central axis (22) of the trailer (1A).

The shape and/or width of boat hull (20) which varies along its length. As boat (18) moves onto the trailer (1A) the boat hull (20) applies pressure to roller assemblies at different angles. This causes roller assemblies (2, 3) to pivot around pivot points (6). Inner end (7) of roller assemblies (2, 3) moves upwards while outer ends (8) pivot downwards.

This changes the orientation of the roller assemblies (2, 3) with respect to each other.

The change in orientation of the roller assemblies (2, 3) as the boat hull (20) moves onto trailer (1A) and is best seen in FIGS. 4A-4C.

The change in angle ensures that the roller assemblies (2, 3) are better able to engage the surface of the boat hull (20) as that moves onto trailer (1A). Accordingly, the roller assemblies (2, 3) are better able to transfer rotation of force to the boat. This may assist in loading and unloading of the boat onto the trailer.

The roller assemblies (2, 3) continue rotating until the boat is moved entirely onto the trailer (1A).

Boat hull (20) has plaining lines (23) which extend along its length. If the rollers (9) contact the plaining lines then the rollers (9) can deform (bend) around the plaining lines (23). This is achieved by the overhang (16) providing the roller (9) with a degree of flexibility.

The rollers (9) deforming helps to ensure that the roller assemblies (2, 3) can maintain contact with the boat hull. This is important in ensuring that the loading mechanisms (1) can apply sufficient force to the boat hull to move it onto the trailer (1A).

The inventors have found that one of the most difficult aspects of loading a boat onto a trailer is moving the boat (18) when it is substantially out of the water e.g. getting the last 1-2 metres of the boat (18) onto the trailer (1A). At this stage, all of the boat's weight is bearing on the roller assemblies (2, 3).

The hydraulic pump (12) is disengaged so that roller assemblies (2, 3) stop rotating.

To unload the boat from the trailer (1A) the remote sends a signal to the pump (12). The pump forces hydraulic fluid through the drive motors (11) in a direction which causes the drive motor (11) to rotate axle (10) in an appropriate direction. Rotation of axle (10) causes rollers (9) to rotate in a corresponding manner. The rollers (9) apply force to boat hull (20) to move boat (18) with respect to the trailer (1A) and into body of water (17).

It should be appreciated that the present invention has a number of advantages over the prior art.

The roller assemblies being laterally spaced across the width of the boat trailer (1A) is important. Due to this configuration, the roller assemblies (2, 3) are in-use on either side of the boat's centre line. Therefore, the roller assemblies (2, 3) are able to provide an aligning mechanism to move a boat into an optimum position to be loaded onto the trailer.

In addition, this enables the roller assemblies to move effectively transfer force to the boat hull so as to load and unload the boat onto the trailer (1A).

That the roller assemblies are able to move relative to each other also helps them to maintain contact with the boat hull. Again, this is important in helping the roller assemblies (2, 3) to transfer force to and thereby move the boat hull.

The configuration and properties of the rollers may also important in ensuring that the invention is successful. The inventors have identified the particular ranges of hardness as providing particular advantages.

Other advantages may include but are not limited to:
Being cost effective to manufacture;
Reliable and less prone to mechanical failure than existing boat trailer mechanisms;
Can be easily retrofitted to existing boat trailers;
Can be easily adapted to work with boats of different sizes, shapes, and dimensions.

Aspects of the present invention have been described by way of example only and it should be appreciated that modifications and additions may be made thereto without departing from the scope thereof as defined in the appended claims.

1. A loading mechanism, including
a first roller assembly and second roller assembly,
at least one mounting for the first and second roller assemblies,
wherein the first roller assembly and second roller assembly each have a longitudinal axis,
a drive mechanism configured to rotate the first roller assembly and second roller assembly, so as to move an object,
wherein as the weight of the object applies pressure to at least one of the first and second roller assemblies the mounting allows the roller assemblies to move so as to change the angle between the longitudinal axis of the first and second roller assemblies.

2. The loading mechanism as claimed in claim 1, including a cradle having a forward end, backward end, and a centre line.

3. The loading mechanism as claimed in claim 2, including at least two roller assemblies that positioned on distal sides of the centre line to each other.

4. The loading mechanism as claimed in claim 2, wherein at the first and second roller assemblies are positioned substantially towards the backward end of the cradle.

5. The loading mechanism as claimed in claim 1, wherein at least one of the roller assemblies includes an axle and one or more rollers.

6. The loading mechanism as claimed in claim 5, wherein the drive mechanism is configured to rotate the first and second roller assemblies at a rate of between 6 to 15 revolutions per minute.

7. The loading mechanism as claimed in claim 6, wherein the drive mechanism is configured to rotate the rollers at a rate of 10 revolutions per minute.

8. The loading mechanism as claimed in claim 7, wherein the mounting is configured to enable the first and second roller assemblies to move pivotally.

9. The loading mechanism as claimed in claim 8, wherein the mounting is configured to move the first and second roller assemblies to a default position.

10. The loading mechanism as claimed in claim 9, wherein the default position is a V shape when viewed along the centre line.

11. The loading mechanism as claimed in claim 10, wherein the internal angle of the V is in the range substantially 40 degrees to 50 degrees.

12. The loading mechanism as claimed in claim 5, wherein the rollers have an overhang.

13. The loading mechanism as claimed in claim 12, wherein the rollers have a shore hardness in the range of substantially 40 to 80.

14. The loading mechanism as claimed in claim 13, wherein the rollers have a shore hardness of substantially 45.

15. A trailer including a loading mechanism as claimed in claim 1.

16. A loading method wherein the method uses a loading including at least two roller assemblies, a drive mechanism, and at least one mounting for the roller assemblies, the method including the steps of:
(a) using the drive mechanism to rotate the at least two roller assemblies so as to move the object and
wherein the weight of the object applies pressure to the roller assemblies so as to cause the roller assemblies to move and thereby change the orientation of at least two of the roller assemblies relative to each other.

17. A kitset of parts, including
at least two roller assemblies,
at least one mounting for the at least two roller assemblies,
a drive mechanism configured to in use rotate the at least two roller assemblies,
instructions to secure the kit set of parts to a trailer,
wherein the instructions teach a person to configure the components the kitset such that when assembled and in use, the drive mechanism rotates the at least two roller assemblies so as move an object, and
wherein as the weight of the object applies pressure to the at least two roller assemblies the mounting allows the roller assemblies to move so as to change the orientation of at least two of the roller assemblies relative to each other.

18-20. (canceled)
